(19) United States
(12) Patent Application Publication
(10) Pub. No.: US 2025/0046284 A1
(43) Pub. Date: Feb. 6, 2025

(54) ELECTRONIC PERCUSSION INSTRUMENT, CONTROL DEVICE, VELOCITY CALCULATION METHOD, AND NON-TRANSITORY COMPUTER READABLE MEDIUM

(71) Applicant: Roland Corporation, Shizuoka (JP)

(72) Inventor: Marori Yoshioka, Shizuoka (JP)

(73) Assignee: Roland Corporation, Shizuoka (JP)

(21) Appl. No.: 18/754,142

(22) Filed: Jun. 25, 2024

(30) Foreign Application Priority Data
Aug. 1, 2023 (JP) 2023-125312

(51) Int. Cl. G10H 3/14; G10H 1/00; G10H 1/32

(52) U.S. Cl. CPC G10H 3/146; G10H 1/0008; G10H 1/32

(57) ABSTRACT

In an electronic drum 1, a head sensor 8 that detects strike to a head 5 and a rim sensor that detects vibration of a rim 6 and a body part 2 are provided. A velocity Vc is calculated based on a peak value Pc of the head sensor 8 detected during a scan time ScT since a beginning of the strike to the head 2 is detected and an energy value Er of the rim sensor 9. The rim sensor 9 detects the vibration of the body part 2 or the rim 6 where the head 5 is provided. Therefore, the sensitivity of the rim sensor 9 with respect to the strike to the peripheral part of the head 5 is higher than the sensitivity of the head sensor 8.

### CROSS-REFERENCE TO RELATED APPLICATION

This application claims the priority benefit of Japan application serial no. 2023-125312, filed on Aug. 1, 2023. The entirety of the above-mentioned patent application is hereby incorporated by reference herein and made a part of this specification.

### BACKGROUND

### Technical Field

The disclosure relates to an electronic percussion instrument, a control device, a velocity calculation method, and a computer program.

### Description of Related Art

Patent Document 1 discloses an electronic percussion instrument having a head 5 formed as a strike surface struck by a stick etc., and a head sensor 21 provided below the center of the head 5. A cushion member 24 is provided between the head 5 and the head sensor 21, and the vibration at the time when the head 5 is struck by a stick, etc., is transmitted to the head sensor 21 via the cushion member 24. In addition, the velocity is calculated from an output value based on the vibration from the head 5 as detected by the head sensor 21, and a musical sound is output in accordance with the calculated velocity.

### PRIOR ART DOCUMENT(S)

### Patent Document(s)

[Patent Document 1] Japanese Laid-open No. 2004-198657

Meanwhile, the head sensor 21 is provided in a lower part at the center of the head 5. Accordingly, even with a strike of the same intensity, the sensitivity of the head sensor 21 with respect to the strike to the peripheral part of the head 5 is lower than the sensitivity with respect to the strike to the central part of the head 5. The velocity with respect to the strike to the peripheral part of the head 5 calculated from the output value of the head sensor 21 is smaller than the velocity with respect to the strike to the central part of the head 5 through the strike of the same intensity from which the same velocity is supposed to be calculated. Accordingly, an issue that the accuracy of the velocity with respect to the strike to the peripheral part of the head is decreased may arise.

The disclosure provides an electronic percussion instrument, a control device, a velocity calculation program, and a velocity calculation method capable of increasing the accuracy of the velocity with respect to the strike to the peripheral part of the head.

### SUMMARY

An electronic percussion instrument according to an aspect of the disclosure includes: a housing; a head, provided in the housing and forming a strike surface; a head sensor, detecting a strike to the head; a housing sensor, detecting vibration of the housing; a head result acquisition unit, acquiring a detection result from the head sensor; a housing result acquisition unit, acquiring a detection result from the housing sensor; and a velocity calculation unit, calculating a velocity at a time when the head is struck based on the detection result acquired by the head result acquisition unit and the detection result acquired by the housing result acquisition unit.

A control device according to an aspect of the control disclosure is provided for controlling a sound source part based on a detection result of a head sensor that detects strike to a head forming a strike surface of a percussion instrument and a detection result from a housing sensor that detects vibration of a housing of the percussion instrument. The control device includes: a head result acquisition unit, acquiring a detection result from the head sensor; a housing result acquisition unit, acquiring a detection result from the housing sensor; and a velocity calculation unit, calculating a velocity at a time when the head is struck based on the detection result acquired by the head result acquisition unit and the detection result acquired by the housing result acquisition unit.

A non-transitory computer readable medium according to an aspect of the disclosure stores a velocity calculation program. The velocity calculation program causes a computer to execute a velocity calculation process that calculates a velocity. The velocity calculation program causes the computer to execute: a head result acquisition step of acquiring a detection result from a head sensor detecting a strike to a head forming a strike surface of an electronic percussion instrument; a housing result acquisition step of acquiring a detection result from a housing sensor detecting vibration of a housing of the electronic percussion instrument; and a velocity calculation step of calculating a velocity of the strike based on a detection result acquired in the head result acquisition step and a detection result acquired in the housing result acquisition step.

In addition, a velocity calculation method according to an aspect of the disclosure includes: a head result acquisition step of acquiring a detection result from a head sensor detecting a strike to a head forming a strike surface of an electronic percussion instrument; a housing result acquisition step of acquiring a detection result from a housing sensor detecting vibration of a housing of the electronic percussion instrument; and a velocity calculation step of calculating a velocity of the strike based on a detection result acquired in the head result acquisition step and a detection result acquired in the housing result acquisition step.

### BRIEF DESCRIPTION OF THE DRAWINGS

FIG. 1 is a view illustrating a configuration of an electronic drum.

FIG. 2A is a diagram illustrating output waveforms of a head sensor and a rim sensor in the case where the strike position is at the center of a head (with a diameter of 12 inches). FIG. 2B is a diagram illustrating output waveforms of the head sensor and the rim sensor in the case where the strike position is in a distance of 70 mm from the center of the head (with a diameter of 12 inches). FIG. 2C is a diagram illustrating output waveforms of the head sensor and the rim sensor in the case where the strike position is in a distance of 140 mm from the center of the head (with a diameter of 12 inches).

FIG. 3 is a functional block diagram of the electronic drum.

FIG. 4A is a block diagram illustrating an electrical configuration of an electronic drum. FIG. 4B is a schematic diagram illustrating rim coefficient data. FIG. 4C is a diagram illustrating a relationship between strike position and weighting coefficient.

FIG. 5 is a flowchart of a main process.

FIG. 6 is a block diagram representing an electrical configuration of a control device in a modified example.

### DESCRIPTION OF THE EMBODIMENTS

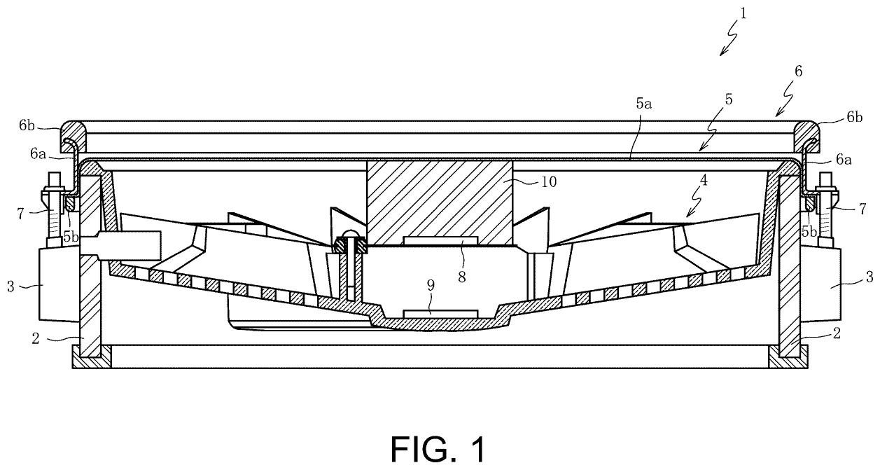

In the following, the exemplary embodiments are described with reference to the drawings. Firstly, the configuration of an electronic drum 1 of the embodiment is described with reference to FIG. 1. FIG. 1 is a view illustrating the configuration of the electronic drum 1. FIG. 1 represents a cross-section of the electronic drum 1, and a portion of the electronic drum 1 is omitted from illustration. In addition, the upper side of FIG. 1 is defined as the top of the electronic drum 1, and the lower side is defined as the bottom of the electronic drum 1.

As shown in FIG. 1, the electronic drum 1 is an electronic percussion instrument (percussion instrument) simulating a drum played by the player by using a stick, etc. The electronic drum 1 has a body part 2, a sensor frame 4, a head 5, and a rim 6, and may be configured by assembling through stacking the components in order and fixing the rim 6 to the body part 2.

The body part 2 is a member that serves as a skeleton (housing) of the electronic drum 1, and is formed in a cylindrical shape by using a wooden material or a resin material. The sensor frame 4, which will be described afterwards, is accommodated in the inner peripheral part of the body part 2, and the head 5 and the rim 6, which will be described afterwards, are provided on the upper end side of the body part 2. In addition, multiple engagement parts 3 are provided on the outer peripheral part of the body part 2.

In the sensor frame 4, a head sensor 8 and a rim sensor 9, which will be described afterwards, are installed to the electronic drum 1. The sensor frame is a component that transmits, to the rim sensor 9, the vibration resulting from the strike to the rim 6. The head 5 is a component configured as a strike surface struck by a stick, etc., and is configured by bonding, to a frame 5b, a strike member 5a woven in a mesh shape by using synthetic fibers.

The strike surface of the electronic drum 1 is configured by such head 5, has a circular shape when viewed from the top, and has a diameter of about 12 inches (about 305 mm). The shape of the strike surface of the electronic drum 1 is not limited to a circular shape, and may also be in other shapes, such as an oval shape, a rectangular shape, etc. In addition, the diameter of the strike surface of the electronic drum 1 is not limited to 12 inches. The diameter may be 12 inches or more or 12 inches or less.

The rim 6 fixes the sensor frame 4 and the head 5 to the body part 2, and is a component applying a tensile force to the head 5 by surrounding the outer periphery of the head 5. A rim metal fitting 6a and a cover member 6b are provided at the rim 6. The rim metal fitting 6a is a component to which an engagement bolt 7, which will be described afterwards, is installed. The cover member 6b is a component formed by a material having an elasticity, such as rubber, and covering the upper end of the rim metal fitting 6a. Due to a cushion effect of the cover member 6b having an elasticity, the strike sound of the rim 6 that occurs at the time of a rim shot can be reduced.

The engagement bolt 7 is a component that fixes the rim 6 to the body part 2. The engagement bolts 7 are provided in the same quantity as the engagement parts 3 provided in the body part 2, and are provided at substantially the same intervals in the circumferential direction of the rim metal fitting 6a. With such engagement bolts 7 being screwed into the engagement parts 3, the rim 6 is fixed to the body part 2, the rim 6 and the sensor frame 4 are linked via the head 5, and a transmission path of the vibration at the time of the rim shot to the rim sensor 9, which will be described afterwards, is formed.

At the center of the sensor frame 4, the head sensor 8 and the rim sensor 9 are provided. The head sensor 8 is a sensor that detects that the strike member 5a of the head 5 is struck, and is formed by a piezoelectric element. The head sensor 8 is provided at the upper part at the center of the sensor frame 4. The cushion member 10 formed by an elastic member, such as sponge, is inserted between the head sensor 8 and the head 5, and the vibration when the strike member 5a of the head 5 is struck by a stick, etc., is transmitted to the head sensor 8 via the cushion member 10. In addition, the state of the transmitted vibration is detected by the head sensor 8. It is noted that the head sensor 8 is not limited to being provided at the center of the sensor frame 4, that is, the center of the head 5. For example, the head sensor 8 may also be provided at a position deviated toward the side of the body part 2 from the center of the head 5.

The rim sensor 9 is a sensor that detects the vibration due to the strike to the rim 6, and is formed by a piezoelectric element like the head sensor 8. The rim sensor 9 is provided at a lower part at the center of the sensor frame 4. The sensor frame 4 contacts the rim 6 via the head 5. Therefore, the vibration at the time when the cover member 6b of the rim 6 is struck by a stick, etc., is transmitted to the rim sensor 9 via the sensor frame 4, and the state of the transmitted vibration is detected by the rim sensor 9.

In addition, the sensor frame 4 also contacts the strike member 5a of the head 5 and the body part 2. Therefore, the vibration of the strike to the strike member 5a of the head 5 is transmitted to the sensor frame 4 directly or via the body part 2 and detected by the rim sensor 9. In the following, the “strike to the strike member 5a of the head 5” is briefly referred to as “strike to the head 5”, and the “strike to the cover member 6b of the rim 6” is similarly briefly referred to as “strike to the rim 6”. The head sensor 8 and the rim sensor 9 are not limited to being formed by piezoelectric elements, and may also be formed by other components that detect vibration.

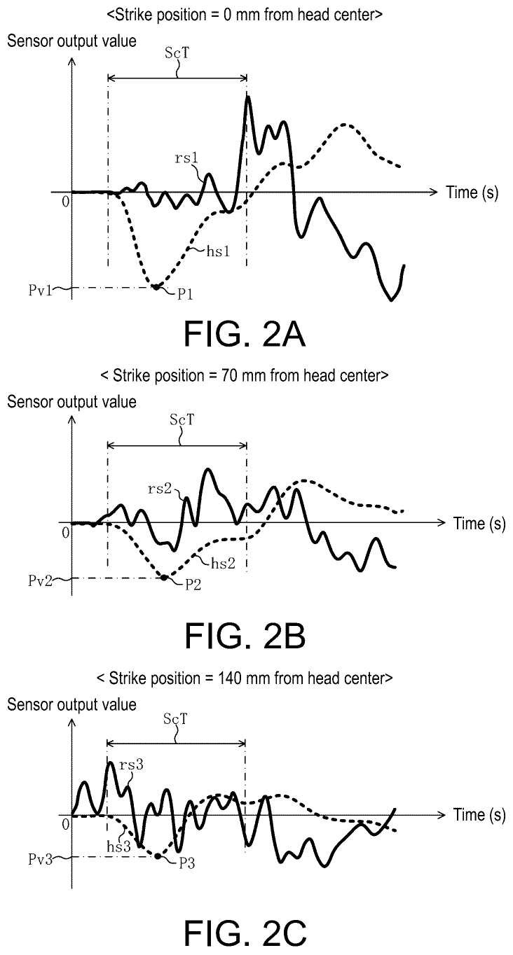

In the electronic drum 1, the musical sound output at the time when the head 5 is struck is generated and output based on a strike position that is a position where the head 5 is struck and a velocity Vc representing the strike intensity calculated when the head 5 is struck. In the embodiment, the velocity Vc used for generating such musical sound is not calculated only by using the output value of the head sensor 8 that detects the state of the vibration of the head 5, but also the output value of the rim sensor 9. A calculation process of the velocity Vc of the embodiment is described with reference to FIGS. 2A to 2C.

FIG. 2A is a diagram illustrating output waveforms hs1 and rs1 of the head sensor 8 and the rim sensor 9 in the case where the strike position is at the center of the head 5 (with a diameter of 12 inches). FIG. 2B is a diagram illustrating output waveforms hs2 and rs2 of the head sensor 8 and the rim sensor 9 in the case where the strike position is 70 mm from the center of the head 5 (with a diameter of 12 inches). FIG. 2C is a diagram illustrating output waveforms hs3 and rs3 of the head sensor 8 and the rim sensor 9 in the case where the strike position is 140 mm from the center of the head 5 (with a diameter of 12 inches).

In FIGS. 2A to 2C, respectively, the output waveforms, which are the waveforms of the transition of the output values respectively output by the head sensor 8 and the rim sensor 9 in the case where the respective strike positions of the head 5 are struck at the same intensity, are represented. In addition, the output waveform of the head sensor 8 is represented by using a broken line, and the output waveform of the rim sensor 9 is represented by using a solid line.

The output waveforms hs1 and rs1 in FIG. 2A represent the waveforms of the output values detected by the head sensor 8 and the rim sensor 9, respectively, in the case where the strike position is the center of the head 5, i.e., the immediate above of the head sensor 8 is struck. In addition to the above, FIG. 2A also represents a scan time ScT, which is a predetermined period from the time point when the beginning of the strike is detected. The scan time Sct is also represented in FIGS. 2B and 2C.

In the embodiment, “2-millisecond interval” is set as the length of the scan time ScT. Nevertheless, the length of the scan time ScT is not limited to the 2-millisecond interval, and may be equal to or more than 2 milliseconds and may also be equal to or less than 2 milliseconds. For example, the scan time ScT may also be set in accordance with the size (diameter) of the head 5 or the material of the head 5, and it may also be configured that the user can arbitrarily set the scan time ScT. In addition, in the embodiment, a conventional technique can be used to detect the beginning of the strike. Therefore, detailed description is omitted.

In the case where the head 5 is struck, the head 5 is pushed downward due to the strike. Therefore, the head sensor 8 to which the pushing is transmitted via the cushion member 10 outputs a negative output value in accordance with the pushing amount. After an output value Pv1 at a peak value P1 when the head 5 is pushed to the lowermost is detected, the position of the head 5 returns to the original position before the strike through the restoring force of the strike member 5a formed by synthetic fibers. Together with this, the output value detected by the head sensor 8 also increases after the peak value P1.

Meanwhile, in the rim sensor 9, there is a distance between the center of the head 5, which is the strike position, and the sensor frame 4. Therefore, after a short period since the change of the output waveform hs1 obtained by using the head sensor 8 starts, the change of the output waveform rs1 obtained by using the rim sensor 9 gradually starts, and then the amplitude of the output waveform rs1 increases.

In the output waveform rs1, such waveform moves up and down frequently. In other words, the frequency of the output waveform rs1 is higher than the frequency from the output waveform hs1 obtained by using the head sensor 8. This is because the rigidity of the body part 2, the sensor frame 4, and the rim 6, which form the transmission path from the head 5 toward the rim sensor 9, is higher than that of the percussion instrument 5a whose vibration is detected by the head sensor 8. The head sensor 8 and the rim sensor 9 are sensors that output positive or negative output values. However, the disclosure is not limited thereto. The head sensor 8 and the rim sensor 9 may also be sensors that output only positive values.

Then, as shown in FIG. 2B, the output waveforms hs2 and rs2 obtained from the head sensor 8 and the rim sensor 9 in the case where the strike position is on the outer side from the center of the head 5, which is 70 mm from the center of the head 5, are waveforms respectively similar to the output waveforms hs1 and rs2. However, since the strike position is further away from the head sensor 8 than the case of FIG. 2A, an output value Pv2 detected at a peak value P2 of the output waveform hs2 is smaller than the output value Pv1 detected at the peak P1 of the output waveform hs1 of FIG. 2A.

Meanwhile, the strike position in FIG. 2B is closer to the sensor frame 4 than the case of FIG. 2A. Therefore, the timing at which the rim sensor 9 detects the beginning of the vibration and the output waveform rs2 starts to change is earlier than the output waveform rs1 of FIG. 2A.

As shown in FIG. 2C, the output waveforms hs3 and rs3 obtained from the head sensor 8 and the rim sensor 9 in the case where the strike position is on the further outer side, which is 140 mm from the center of the head 5, are waveforms whose shapes are respectively similar to the output waveforms hs1 and hs2 as well as rs1 and rs2. Since the strike position is further away from the head sensor 8 than the case of FIG. 2B, an output value Pv3 detected at a peak P3 of the output waveform hs3 is smaller than the output value Pv2 detected at the peak P2 of the output waveform hs2 of FIG. 2B.

Meanwhile, the strike position in FIG. 2C is further closer to the sensor frame 4 than the case of FIG. 2B. Therefore, the timing at which the rim sensor 9 detects the beginning of the vibration and the output waveform rs3 starts to change is earlier than the output waveform rs2 of FIG. 2B.

Conventionally, calculation is made based on the maximum value of the magnitude of the amplitude detected by the head sensor 8 in the scan time ScT, i.e., based on the output values Pv1 to Pv3 at the peaks P1 to P3 in FIGS. 2A to 2C. Meanwhile, as described above, even in the case where the head 5 is struck at the same velocity, the further away the distance of the strike position is from the head sensor 8, the smaller the output value of the head sensor 8. That is, the longer the distance of the strike position from the head sensor 8, the lower the sensitivity of the head sensor 8 with respect to the strike. When the velocity Vc is calculated based on the output value of the head sensor 8, even in the case where the head 5 is actually struck at the same strength, the further the distance of the strike position from the head sensor 8, the smaller value of the velocity Vc is calculated. Therefore, the accuracy of the calculated velocity Vc is decreased.

Here, in the output waveforms of the rim sensor 9, as shown in FIGS. 2A to 2C, the greater the distance of the strike position from the head sensor 8, the earlier the beginning of the strike to the head 5 is detected. Therefore, it can be said that the output value of the rim sensor 9 detected during the scan time ScT correctly reflects the strike situation of the peripheral part of the head 5 away from the head sensor 8.

Thus, in the embodiment, the velocity Vc at the time when the head 5 is struck is calculated by combining the output value of the head sensor 8 and the output value of the rim sensor 9. Specifically, during the scan time Sct since the beginning of the strike to the head 5 is detected, the maximum values of the absolute values of the output values detected by the head sensor 8, that is, the absolute values of the output values Pv1 to Pv3 detected by the peaks P1 to P3 in FIGS. 2A to 2C are set as peak values Ph, and in the case where the energy of the output value detected by the rim sensor 9 during an energy calculation period, which is a predetermined period during the scan time ScT, the velocity Vc is calculated by using Formula 1 below.

$$[ Formula 1 ]$$

$$Vc = Ph + α \cdot Er \qquad ( Formula 1 )$$

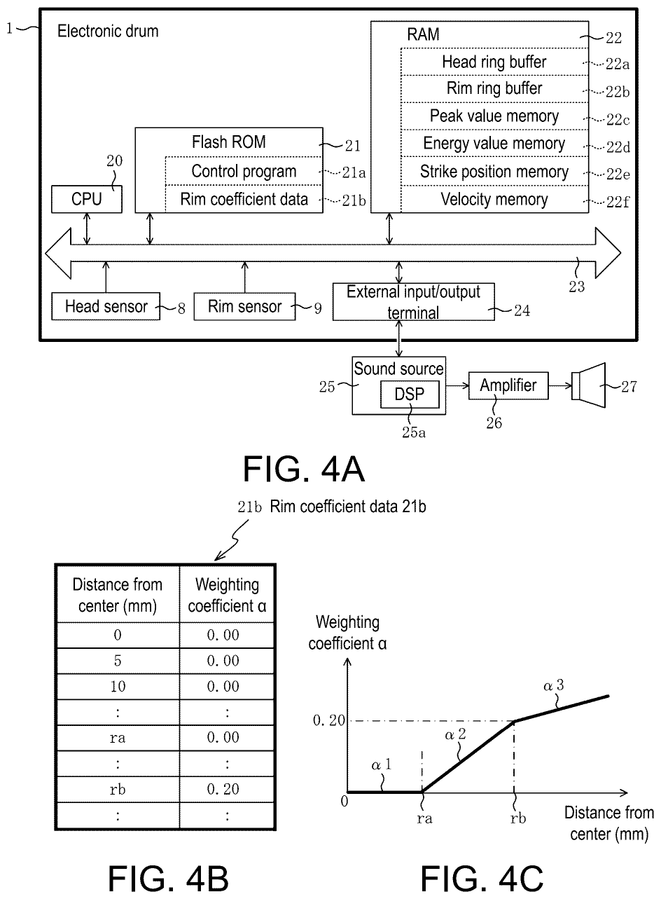

That is, the velocity Vc is calculated by adding up a multiplication value of a weighting coefficient α and an energy value Er of the rim sensor 9 to the peak value Ph of the head sensor 8. Here, the energy value Er of the output value of the rim sensor 9 is set as a value obtained by adding up the absolute values of the output values detected by the rim sensor 9 in an energy calculation period during the scan time ScT, i.e., as an integral value of the absolute values of the output values detected by the rim sensor 9. Here, “energy calculation period” is a period set in accordance with the size of the diameter of the head 5. For example, such period may be a period from the beginning of the strike to one millisecond after the beginning of the strike during the scan time ScT. In addition, a multiplied to the energy value Er is a weighting coefficient and changes in accordance with the strike position of the head 5. The weighting coefficient α will be described afterwards with reference to FIGS. 4A to 4C.

Accordingly, the velocity Vc is calculated by the energy value Er of the rim sensor 9 in addition to the peak value Ph of the head sensor 8. The rim sensor 9 detects the vibration of the body part 2 or the rim 6 where the head 5 is provided. Therefore, the sensitivity of the rim sensor 9 with respect to the strike to the peripheral part of the head 5 is higher than the sensitivity of the head sensor 8. By using the energy value Er of the rim sensor 9 in the calculation of the velocity Vc, and the accuracy of the velocity Ve calculated with respect to the strike to the peripheral part of the head 5 can be increased.

The energy value Er of the rim sensor 9 used in the calculation of the velocity Ve is set as an integral value obtained by adding up the absolute values of the output values of the rim sensor 9. As shown in FIGS. 2A to 2C, the frequencies of the output waveforms rs1 to rs3 of the rim sensor 9 are higher than the frequencies of the output waveforms hs1 to hs3 of the head sensor 8 and move up and down frequently. Therefore, if the output values of the rim sensor 9 are directly added up, the positive and negative values of the output values are offset and the strike situation detected by the rim sensor 9 cannot be accurately represented.

Thus, by making the energy value Er of the rim sensor 9 an integral value obtained by adding up the absolute values of the output values of the rim sensor 9, the magnitude of the output value can be reflected by the energy value Er, regardless of whether the detection values are positive or negative. Therefore, the strike situation detected by the rim sensor 9 can be accurately reflected.

Moreover, such energy value Er is generally a value proportional to the squared magnitudes (i.e., magnitudes of the output values) of the amplitudes of the output waveforms rs1 to rs3 and therefore a value reflecting the strength of the strike in the peripheral part of the head 5 (i.e., the magnitudes of the amplitudes of the output waveforms rs1 to rs3). Accordingly, the situation about the strength of the strike to the head 5 is accurately reflected by the energy value Er, and therefore the accuracy of the calculated velocity Vc can be facilitated.

The rim sensor 9 detecting the strike to the rim 6 (rim shot) can be used as a sensor that detects the strike of the peripheral part of the head 5. That is, in addition to detecting a rim shot, the rim sensor 9 can also detect the strike to the peripheral part of the head 5. Therefore, even if the number of sensors mounted to the electronic drum 1 is the minimum (two, i.e., the head sensor 8 and the rim sensor 9 in the embodiment), highly accurate calculation of the velocity Vc of the strike of the head 5 and the detection of the rim shot can be realized.

In addition, by using the peak value Ph of the head sensor 8 in the calculation of the velocity Vc as in the conventional art, the velocity Ve due to the strike of the central part of the head 5 can also be highly accurately calculated. In this way, by combining the peak value Ph of the head sensor 8 and the energy value Er of the rim sensor 9 to calculate the velocity Vc, the highly accurate velocity Vc can be calculated throughout the entire region of the head 5 struck by a stick, etc.

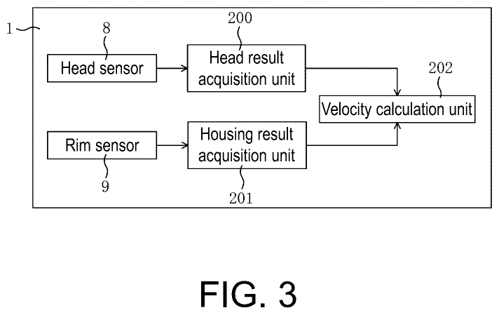

Then, the function of the electronic drum 1 is described with reference to FIG. 3. FIG. 3 is a functional block diagram of the electronic drum 1. The electronic drum 1 includes a head result acquisition unit 200, a housing result acquisition unit 201, and a velocity calculation unit 202.

The head result acquisition unit 200 is a unit that acquires the detection result (output value) from the head sensor 8, and is realized by a CPU 20, which will be described subsequently, in FIG. 4A. The housing result acquisition unit 201 is a unit that acquires the detection result (output value) from the rim sensor 9, and is realized by the CPU 20. The velocity calculation unit 202 is a unit that calculates the velocity Vc at the time when the head 5 is struck based on the detection result acquired by the head result acquisition unit 200 and the detection result acquired by the housing result acquisition unit 201.

In the electronic drum 1, the velocity Vc at the time when the head 5 is struck is calculated based on the detection result from the head sensor 8 and the detection result from the rim sensor 9. The rim sensor 9 detects the vibration of the body part 2 where the head 5 is provided. Therefore, the sensitivity of the rim sensor 9 to the strike of the peripheral part of the head 5 is higher than that of the head sensor 8. By using the detection result from the rim sensor 9 in the calculation of the velocity Vc, the accuracy of the velocity Vc with respect to the strike to the peripheral part of the head 5 can be increased.

In the following, the electrical configuration of the electronic drum 1 is described with reference to FIGS. 4A to 4C. FIG. 4A is a block diagram illustrating the electrical configuration of the electronic drum 1. The electronic drum 1 has the CPU 20, a flash ROM 21, and a RAM 22, which are respectively connected via a bus line 23. In addition, the bus line 23 is further respectively connected with the head sensor 8 and the rim sensor 9, as well as an external input/output terminal 24. The external input/output terminal 24 is connected with a sound source 25. An amplifier 26 is connected with the sound source 25, and a speaker 27 is connected with the amplifier 26.

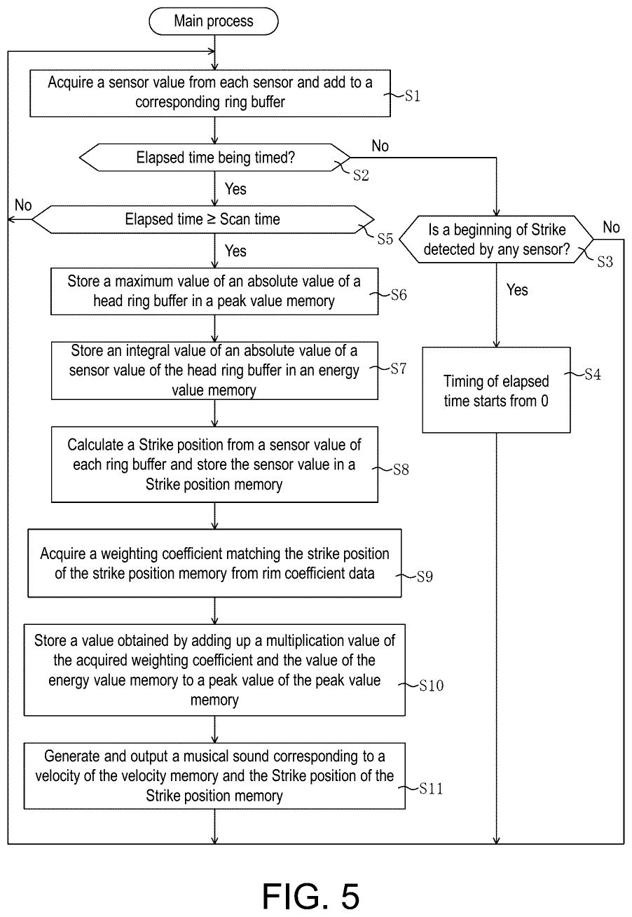

The CPU 20 is an arithmetic device that controls the respective parts connected by the bus line 23. The flash ROM 21 is a non-volatile storage device rewritably storing a program executed by the CPU 20 and fixed value data, etc., and includes a control program 21a and rim coefficient data 21b. When the control program 21a is executed by the CPU 20, the main process of FIG. 5 is executed. The rim coefficient data 21b is a data table in which the weighting coefficient α in FIGS. 2A to 2C is stored. Here, the rim coefficient data 21b are described with reference to FIGS. 4B, 4C.

FIG. 4B is a schematic diagram illustrating the rim coefficient data 21b. FIG. 4C is a diagram illustrating a relationship between the strike position and the weighting coefficient α. As shown in FIG. 4B, the weighting coefficient α corresponding to the strike position of the head 5 is stored in the rim coefficient data 21b. As the “strike position of the head 5” in the rim coefficient data 21b, a distance between the strike position and the center of the head 5 (representing “distance from the head center” in the figure) is used.

As shown in FIG. 4C, the relationship between the strike position and the weighting coefficient α stored in the rim coefficient data 21b is that the weighting coefficient α increases in accordance with that the strike position moves from the center of the head 5. That is, the value of the weighting coefficient α output from a weighting function that is a function in which the strike position is input is stored in the rim coefficient data 21b.

More specifically, the weighting coefficient α output by using the weighting function is divided into a first interval α1, a second interval α2, and a third interval α3 according to the strike position. The first interval α1 is within an interval of the central part of the head 5, in which the strike position ranges from the center of the head 5 to a position ra (e.g., a position that is 20 mm from the center of the head 5). In the first interval α1, the weighting coefficient is always set as “0”. That is, according to Formula 1 above, the velocity Vc is calculated only from the peak value Ph of the head sensor 8. Accordingly, for the velocity Ve of the strike to the central part of the head sensor 8, the velocity Vc can be accurately calculated by using only the head sensor 8 with favorable sensitivity at the strike position.

The second interval α2 is an interval of the intermediate part of the head 5 from the position ra to a position rb (e.g., at the position of 40 mm from the center of the head 5). In the interval, the weighting coefficient α increases proportionally to the distance from the center of the head 5. That is, in the second interval α2 of the weighting function, the relationship between the distance from the center of the head 5 and the weighting coefficient α is a linear relationship.

Accordingly, even if the sensitivity of the strike at the head sensor 8 decreases and the peak value Ph decreases with the strike position being away from the center of the head 5, the energy value Er of the rim sensor 9 with a high strike sensitivity at the peripheral part of the head 5 is added up in the calculation of the velocity Vc, and the weighting coefficient α, which has a greater value as the strike position is away from the center of the head 5, is multiplied with the energy value Er. Therefore, the accurate velocity Vc can also be calculated in the second interval α2.

The third interval α3 is an interval where the strike position is over the position rb and is at an interval of the peripheral part of the head 5. Even in the interval, the weighting coefficient α increases proportionally to the distance from the center of the head 5 following the second interval α2. In the third interval α3 of the weighting function as well, the relationship between the distance from the center of the head 5 and the weighting coefficient α is linear. However, the slope is set to be smaller than the slope in the case of the second interval α2.

This is because the difference between the output value of the head sensor 8 in the case where a strike position A3 in the third interval α3 is struck and the output value of the head sensor 8 in the case where a strike position B3 moved outward by 10 mm in the radial direction of the head 5 from the strike position A3 is smaller than the difference between the output value of the head sensor 8 in the case where a strike position A2 in the second interval α2 is struck and the output value of the head sensor 8 in the case where a strike position B2 (the strike position B2 is also located in the second interval α2) moved outward by 10 mm in the radial direction of the head 5 from the strike position A2. In other words, this is because the decrease in sensitivity of the head sensor 8 is less in the third interval α3 than in the second interval α2.

In this way, in the slope of the weighting function, by taking the properties of the output value of the head sensor 8 with respect to the strike position into consideration, in the calculation of the velocity Vc, the peak value Ph of the head sensor 8 can be compensated by using the energy value Er of the rim sensor 9. Therefore, the velocity Ve can be accurately calculated without depending on the strike position of the head 5.

The shape of the weighting function of the embodiment, i.e., the positions ra, rb, or the slope of the weighting function are set according to experimentation carried out in advance. The position ra, rb or the slope of the weighting function is not limited to the above. For example, other positions or slopes may also be used in accordance with the size or the material of the head 5 or the material of the body part 2 or the sensor frame 4, etc.

In addition, while three intervals of the weighting functions i.e., α1 to α3, are used, the disclosure is not limited thereto. The number of intervals may be equal to or less than 3, and may also be equal to or more than 3. Moreover, although the relationship between the strike position and the weighting coefficient α in the weighting function is linear, the disclosure is not limited thereto. The relationship between the strike position and the weighting coefficient α in the weighting function may also be non-linear, such as a quadratic function or an exponential function, and the weighting coefficient α with respect to the strike position may also change stepwise.

Referring to FIG. 4A again, the RAM 22 is a memory for rewritably storing various work data, flags, etc., at the time when the CPU 20 executes a program, and is provided with a head ring buffer 22a, a rim ring buffer 22b,a peak value memory 22c in which the peak value Ph is stored; an energy value memory 22d in which the energy value Er is stored; a strike position memory 22e in which the strike position is stored and a velocity memory 22f in which the velocity Vc is stored.

The head ring buffer 22a is a buffer storing the output values of the head sensor 8 of previous 5 milliseconds. The output values of the head sensor 8 are stored in the input order thereof in the head ring buffer 22a. If a new input value of the head sensor 8 is input in the state in which the output values of the head sensor 8 of 5 milliseconds are stored in the head ring buffer 22a, the oldest output value is deleted from the output values stored in the head ring buffer 22a, and then the newly input output value is additionally stored in the head ring buffer 22a.

The rim ring buffer 22b is a buffer storing the output values of the rim sensor 9 of the previous 5 milliseconds. In the rim ring buffer 22b as well, the output values of the rims sensor 9 are stored in the input order thereof. If a new output value of the rim sensor 9 is input in the state in which the output values of the rim sensor 9 of 5 milliseconds are stored in the rim ring buffer 22b, the oldest output value is deleted from the output values stored in the rim ring buffer 22b, and then the newly input output value is additionally stored in the rim ring buffer 22b.

The period of the output values that can be stored in the head ring buffer 22a and the rim ring buffer 22b are not limited to five milliseconds. The period may be equal to or less than five milliseconds and may also be equal to or greater than 5 milliseconds, as long as the period is equal to or more than the scan time ScT (2 milli-seconds in the embodiment).

The external input/output terminal 24 is an interface for transmitting and receiving data with the sound source 25, which will be described afterwards, or other computers. A musical sound generation instruction generated by the electronic drum 1 is transmitted to the sound source 25 via the external input/output terminal 24.

The sound source 25 is a device that controls the tone of the musical sounds (strike sounds) or various effects, etc., in accordance with an instruction from the CPU 20, and a digital signal processor (DSP) 25a performing the arithmetic process, such as a filter or an effect on the waveform data is built therein. The musical sound processed by the sound source 25 is output as an analog musical sound signal. The amplifier 26 is a device that amplifies the analog musical sound signal output from the sound source 25, and the amplified analog musical sound signal is output to the speaker 27. The speaker 27 outputs, as a musical sound, the analog musical sound signal amplified by the amplifier 26 as a musical sound.

In the following, the process executed by the CPU is described with reference to FIG. 5. FIG. 5 is a flowchart of the main process. The main process is a process executed by the CPU 20 after the power of the electronic drum 1 is turned on. In the main process, firstly, the output value is acquired from the head sensor 8 and added to the head ring buffer 22a, and the output value is acquired from the rim sensor 9 and added to the rim ring buffer 22b (S1). After the process of S1, whether an elapsed time, which is a time period timed from the time when the beginning of the strike of the head 5 is detected, is being timed is determined (S2).

In the process of S2, in the case where the elapsed time is not being timed (S2: No), whether the beginning of the strike is detected by the head sensor 8 or the rim sensor 9 is determined with reference to the head ring buffer 22a, the ring buffer 22b (S3). Since a conventional technique can be used to detect the beginning of the strike in the process of S3, the description is omitted. In the process of S3, in the case where the beginning of the strike is detected (S3: Yes), the timing of the elapsed time starts from 0 (S4).

In the process of S2, in the case where the elapsed time is being timed (S2: Yes), whether the elapsed time is equal to or more than the scan time ScT (a 2-millisecond interval) is determined (S5). In the process of S5, in the case where the elapsed time is equal to or more than the scan time (S5: Yes), the maximum value of the absolute values of the output values added during the scan time ScT from the time when the timing of the elapsed time begins among the output values stored in the head ring buffer 22a, i.e., the peak value Ph, is stored in the peak value memory 22c (S6).

After the process of S6, the value obtained by integrating (adding up) the absolute values of the output values added during the energy calculation period in FIGS. 2A to 2C and the period of the scan time ScT since the timing of the elapsed time starts, among the output values stored in the rim ring buffer 22b, i.e., the energy value Er is calculated and stored in the energy value memory 22d (S7).

After the process of S7, with reference to the head ring buffer 22a, the rim ring buffer 22b, the strike position of the head 5 is calculated and stored in the strike position memory 22c (S8). Since a conventional technique can be used to calculate the strike position in the process of S8, the description is omitted. After the process of S8, the weighting coefficient α corresponding to the strike position of the strike position memory 22e is acquired from the rim coefficient data 21b.

After the process of S9, a value obtained by adding the multiplication value of the weighting coefficient α acquired in the process of S9 and the energy value Er of the energy value memory 22d to the peak value Ph of the peak value memory 22c, that is, the velocity Vc, is calculated and stored in the velocity memory 22f (S10).

After the process of S10, an instruction of generating a musical sound in accordance with the velocity of the velocity memory 22f and the strike position of the strike position memory 22e is output to the sound source 25 (S11). In the sound source 25, the musical sound instructed from the CPU 20 is generated and output to the amplifier 26, and the generated musical sound is output from the speaker 27 connected with the amplifier 26. In the case where the beginning of the strike is not detected in the process of S3 (S3: No), in the case where the elapsed time is shorter than the scan time ScT (S5: No) in the process of S5, or after the processes of S4 and S11, the processes since S1 are repeated.

Although the above embodiments have been explained above, it can be easily inferred that various improvements and modifications are possible.

In the embodiment, the strike of the peripheral part of the head 5 is detected by specifically using the rim sensor 9. However, the disclosure is not limited thereto. For example, a sensor detecting the vibration of the body 2 part and independent from the rim sensor 9 may be added, and the velocity Ve may also be calculated in accordance with the output value based on the strike of the head 5 detected by the sensor.

In the embodiment, the head sensor 8 and the rim sensor 9 are provided in adjacency with the sensor frame 4 that is the same component. However, the disclosure is not limited thereto. For example, in order to suppress the vibration detected by the rim sensor 9 from going around to the head sensor 8, a distance may be provided between the position where the head sensor 8 is provided and the position where the rim sensor 9 is provided in the sensor frame 4, and it may also be that a member that obstructs the propagation between the head sensor 8 and the rim sensor 9 in the sensor frame 4. In addition, in place of providing the head sensor 8 and the rim sensor 9 in the same sensor frame 4, the head sensor 8 and the rim sensor 9 may also be provided separately.

In the embodiment, one head sensor 8 and one rim sensor 9 are provided, respectively, but the configuration is not limited to. Two or more head sensors 8 may be provided, and two or more rim sensors 9 can be provided. In the case where multiple head sensors 8 are provided, as the peak value Ph used in the calculation of the velocity sensor Ve of Formula 1, for example, the average of the peak values detected by the respective head sensors 8 may be used, and it may also be that the peak values of the respective head sensors 8 are respectively multiplied with the corresponding weighting coefficients, and a weighted average value obtained by averaging the multiplication values may also be used.

In addition, in the case where multiple rim sensors 9 are provided, as the energy value Er used for calculating the velocity Vc of Formula 1, for example, an average value of the energy value calculated based on the output values of the respective rim sensors 9 may be used, and a weighted average value of the energy values calculated based on the output values of the respective rim sensors 9 may also be used.

In the embodiment, the velocity Ve is calculated based on the peak value Ph of the head sensor 8 and the energy value Er of the rim sensor 9. However, the disclosure is not limited thereto. For example, in the calculation of the velocity Vc, in place of the peak value Ph of the head sensor 8, the energy value of the head sensor 8 same as the energy value Er of the rim sensor 9 may also be used. In addition, in the calculation of the velocity Vc, in place of the energy value of the rim sensor 9, the peak value of the rim sensor 9 same as the peak value Ph of the head sensor 8 may also be used.

In addition, the energy value Er of the rim sensor 9 is set as the integral value obtained by adding up the absolute values of the output values of the rim sensor 9. However, the disclosure is not limited thereto. For example, the energy value Er of the rim sensor 9 may also be set as the average value of the absolute values of the output values of the rim sensor 9, the median of the absolute values of the output values of the rim sensor 9, or other statistical indices relating to the output values of the rim sensor 9.

In the embodiment, the weighting coefficient α is a value equal to or more than 0 (see FIG. 4B). However, the disclosure is not limited thereto. The weighting coefficient α may also be a value less than 0. For example, by setting the weighting coefficients α of the first interval α1 in FIG. 4B to be less than 0, in Formula 1, the peak value Ph of the head sensor 8 is subtracted by the energy value Er of the rim sensor 9. Accordingly, even if the output value of the head sensor 8 is excessively large due to the strike to the center of the head 5 where the sensitivity of the head sensor 8 is high, the excessive part can be compensated by subtracting the energy value Er of the rim sensor 9, so the velocity Ve can be accurately calculated.

In addition, in the calculation of the velocity Vc, the energy value Er of the rim sensor 9 is multiplied by the weighting coefficient α. However, the disclosure is not limited thereto. For example, the weighting coefficient α may also be added to the energy value Er of the rim sensor 9, the weighting coefficient α may also be subtracted from the energy value Er of the rim sensor 9, and the energy value Er of the rim sensor 9 may also be divided by the weighting coefficient α. It suffices as long as the weighting coefficient α in these cases is set to be able to appropriately calculate the velocity Vc at the time of performing addition, etc., to the energy value Er.

Alternatively, the peak value Ph of the head sensor 8 may also be multiplied by the weighting coefficient α. The weighting coefficient α in such case may be set to be able to appropriately calculate the velocity Vc at the time of multiplying with the peak value Ph. For example, the weighting coefficient α may also be set based on an inverse function of the weighting function in FIG. 4C.

In the embodiment, the electronic drum 1 simulating a drum is exemplified as an electronic percussion instrument. However, the disclosure is not limited thereto. The disclosure may also be appropriately applied to simulating other percussion instruments, such as a bass drum, a snare, a tom, etc. In addition, the control program 21a may also be executable by other information processing devices (computers), such as a personal computer, a portable terminal, etc.

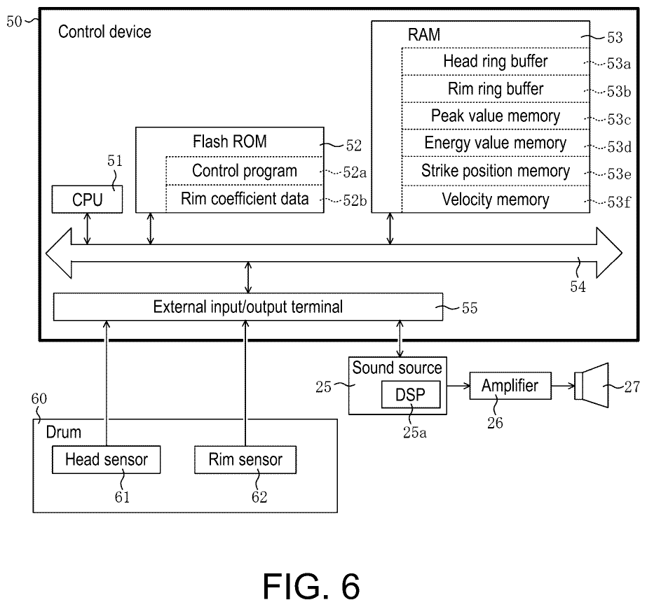

In the embodiment, the head sensor 8 and the rim sensor 9 are provided in the electronic drum 1, and the velocity Vc is calculated in accordance with the output values of the head sensor 8 and the rim sensor 9. However, the disclosure is not limited thereto. For example, as shown in FIG. 6, a control device 50 and a drum 60 that is a percussion instrument provided separately from the control device 50 are connected, and the velocity Vc may be calculated in the control device 50 in accordance with the strike of the drum 60.

More specifically, a CPU 51, a flash ROM 52, a RAM 53, a bus line 54, and an external input/output terminal 55 are provided in the control device 50. These components respectively have functions same as the CPU 20, the flash ROM 21, the RAM 22, the bus line 23, and the external input/output terminal 24 (see FIG. 2A for the respective components) of the electronic drum 1 in FIG. 4A.

A head sensor 61 detecting that the strike surface of the drum 60 is struck and a rim sensor 62 detecting the vibration due to the strike to the rim of the drum 60 are provided in the drum 60. The head sensor 61 and the rim sensor 62 are connected with the external input/output terminal of the control device 50, and the output values from the head sensor 61 and the rim sensor 62 are input to the control device 50 via the external input/output terminal 55.

With the control device 50 and the drum 60 being configured in this way, the velocity Vc may be calculated by executing the main process in FIG. 5 in the CPU 51 of the control device 50. At this time, in the process of S1, etc., of the main process, in place of using the output values from the head sensor 8 and the rim sensor 9 of the electronic drum 1, the output values from the head sensor 61 and the rim sensor 62 input from the external input/output terminal 55 may be used.

In place of the drum 60, an electronic percussion instrument such as the electronic drum 1 may be connected with the control device 50 of FIG. 6, and the velocity Vc may be calculated by the control device 50. In such case, the external input/output terminal 24 of the electronic drum 1 and the external input/output terminal 55 of the control device 50 are connected, the output values of the head sensor 8 and the rim sensor 9 are output from the external input/output terminal 24 of the electronic drum 1, and the output values of the head sensor 8 and the rim sensor 9 input from the external input/output terminal 550 may be used in the control device 5 to execute the main process of FIG. 5.

What is claimed is:

1. An electronic percussion instrument, comprising:
a housing;
a head, provided in the housing and forming a strike surface;
a head sensor, detecting a strike to the head;
a housing sensor, detecting vibration of the housing;
a head result acquisition unit, acquiring a detection result from the head sensor;
a housing result acquisition unit, acquiring a detection result from the housing sensor; and
a velocity calculation unit, calculating a velocity at a time when the head is struck based on the detection result acquired by the head result acquisition unit and the detection result acquired by the housing result acquisition unit.

2. The electronic percussion instrument as claimed in claim 1, wherein the velocity calculation unit calculates the velocity by using an energy value of a waveform resulting from the detection result acquired by the housing result acquisition unit.

3. The electronic percussion instrument as claimed in claim 2, wherein the energy value of the waveform is a value obtained by integrating the detection result acquired by the housing result acquisition unit in a predetermined scan time.

4. The electronic percussion instrument as claimed in claim 1, further comprising:
a strike position detection unit, detecting a strike position of the head; and
a weighting coefficient acquisition unit, acquiring a weighting coefficient with respect to the detection result acquired by the housing result acquisition unit and in accordance with the strike position acquired by the strike position detection unit,
wherein the velocity acquisition unit calculates the velocity at the time when the head is struck based on the detection result acquired by the head result acquisition unit, the detection result acquired by the housing result acquisition unit, and the weighting coefficient acquired by the weighting coefficient acquisition unit.

5. The electronic percussion instrument as claimed in claim 4, wherein the velocity calculation unit calculates the velocity at the time when the head is struck based on the detection result acquired by the head result acquisition unit and a value obtained by multiplying the detection result acquired by the housing result acquisition unit by the weighting coefficient acquired by the weighting coefficient acquisition unit.

6. The electronic percussion instrument as claimed in claim 4, wherein the weighting coefficient acquisition unit acquires the weighting coefficient based on an output of a weighting function that is a function outputting the weighting coefficient that is corresponding from the strike position that is input, and
in the weighting function, the closer the strike position that is input to a periphery from a center of the head, the greater an output value of the weighting coefficient.

7. The electronic percussion instrument as claimed in claim 6, wherein, in the weighting function, a relationship between the strike position and the weighting coefficient is a linear relationship.

8. The electronic percussion instrument as claimed in claim 1, wherein a rim is provided in the housing, so as to surround a periphery of the head, and
the housing sensor detects the strike to the rim.

9. The electronic percussion instrument as claimed in claim 1, wherein the head sensor is provided substantially at a center of the head.

10. A non-transitory computer readable medium, storing velocity calculation program causing a computer to execute a velocity calculation process that calculates a velocity, the velocity calculation program causing the computer to execute:
a head result acquisition step of acquiring a detection result from a head sensor detecting a strike to a head forming a strike surface of a percussion instrument;
a housing result acquisition step of acquiring a detection result from a housing sensor detecting vibration of a housing of the percussion instrument; and
a velocity calculation step of calculating a velocity of the strike based on a detection result acquired in the head result acquisition step and a detection result acquired in the housing result acquisition step.

11. The non-transitory computer readable medium as claimed in claim 10, wherein the velocity is calculated by using an energy value of a waveform resulting from the detection result acquired in the housing result acquisition step.

12. The non-transitory computer readable medium as claimed in claim 11, wherein the energy value of the waveform is a value obtained by integrating the detection result acquired in the housing result acquisition step in a predetermined scan time.

13. The non-transitory computer readable medium as claimed in claim 10, further comprising:
a strike position detection step of detecting a strike position of the head; and
a weighting coefficient acquisition step of acquiring a weighting coefficient with respect to the detection result acquired in the housing result acquisition step and in accordance with the strike position acquired in the strike position detection step,
wherein the velocity is calculated at the time when the head is struck based on the detection result acquired in the head result acquisition step, the detection result acquired in the housing result acquisition step, and the weighting coefficient acquired in the weighting coefficient acquisition step.

14. The non-transitory computer readable medium as claimed in claim 13, wherein the velocity is calculated at the time when the head is struck based on the detection result acquired in the head result acquisition step and a value obtained by multiplying the detection result acquired in the housing result acquisition step by the weighting coefficient acquired in the weighting coefficient acquisition step.

15. The non-transitory computer readable medium as claimed in claim 13, wherein the weighting coefficient is acquired based on an output of a weighting function that is a function outputting the weighting coefficient that is corresponding from the strike position that is input, and
in the weighting function, the closer the strike position that is input to a periphery from a center of the head, the greater an output value of the weighting coefficient.

16. A velocity calculation method, comprising:
a head result acquisition step of acquiring a detection result from a head sensor detecting a strike to a head forming a strike surface of a percussion instrument;
a housing result acquisition step of acquiring a detection result from a housing sensor detecting vibration of a housing of the percussion instrument; and
a velocity calculation step of calculating a velocity of the strike based on a detection result acquired in the head result acquisition step and a detection result acquired in the housing result acquisition step.

17. The method as claimed in claim 16, wherein the velocity is calculated by using an energy value of a waveform resulting from the detection result acquired in the housing result acquisition step.

18. The method as claimed in claim 17, wherein the energy value of the waveform is a value obtained by integrating the detection result acquired in the housing result acquisition step in a predetermined scan time.

19. The method as claimed in claim 16, further comprising:
a strike position detection step of detecting a strike position of the head; and
a weighting coefficient acquisition step of acquiring a weighting coefficient with respect to the detection result acquired in the housing result acquisition step and in accordance with the strike position acquired in the strike position detection step,
wherein the velocity is calculated at the time when the head is struck based on the detection result acquired in the head result acquisition step, the detection result acquired in the housing result acquisition step, and the weighting coefficient acquired in the weighting coefficient acquisition step.

20. The method as claimed in claim 19, wherein the velocity is calculated at the time when the head is struck based on the detection result acquired in the head result acquisition step and a value
the detection result acquired in the housing result acquisition step by the weighting coefficient acquired in the weighting coefficient acquisition step.
